(19) United States
(12) Patent Application Publication
(10) Pub. No.: US 2019/0206355 A1
(43) Pub. Date: Jul. 4, 2019

(54) LIQUID CRYSTAL DISPLAY DEVICE AND METHOD FOR DRIVING LIQUID CRYSTAL PANEL

(71) Applicant: SHARP KABUSHIKI KAISHA, Osaka (JP)

(72) Inventor: HIDEKI MORII, Sakai City (JP)

(21) Appl. No.: 16/222,919

(22) Filed: Dec. 17, 2018

(30) Foreign Application Priority Data
Dec. 28, 2017 (JP) 2017-253987

(51) Int. Cl. G09G 3/36

(52) U.S. Cl. CPC G09G 3/3688; G09G 2310/0264; G09G 2320/0247; G09G 3/3677

(57) ABSTRACT

In a liquid crystal display device, a gate ON voltage (VGH) is supplied to a scanning signal line in a case where the scanning signal line is selected, a gate OFF voltage (VGL) is supplied to the scanning signal line in a case where the scanning signal line is not selected, and a common voltage (Vcom) is supplied to a common electrode. The liquid crystal display device is driven in a first mode and in a second mode in which the liquid crystal display device is driven at a lower frequency than in the first mode. In the second mode, the absolute value of the gate ON voltage (H2) is smaller than that (H1) in the first mode and the common voltage (M2) is different from that (M1) in the first mode.

This Nonprovisional application claims priority under 35 U.S.C. § 119 on Patent Application No. 2017-253987 filed in Japan on Dec. 28, 2017, the entire contents of which are hereby incorporated by reference.

### TECHNICAL FIELD

The present invention relates to a liquid crystal display device.

### BACKGROUND ART

Patent Literature 1 discloses a technique for changing a gate pulse voltage at the time when a drive frequency of the liquid crystal display device is switched to another drive frequency.

### CITATION LIST

### Patent Literature

[Patent Literature 1]

Japanese Patent Application Publication Tokukai No. 2013-186275 (Publication date: Sep. 19, 2013)

### SUMMARY OF INVENTION

### Technical Problem

In a case where a voltage supplied to a scanning signal line is changed at the time when a drive frequency of the liquid crystal display device is switched to another drive frequency, a defect such as flickering in a display may occur.

### Solution to Problem

A liquid crystal display device in accordance with an aspect of the present invention is a liquid crystal display device including: a pixel electrode connected with a data signal line and a scanning signal line, via a transistor; and a common electrode which forms a liquid crystal capacitance, together with the pixel electrode, in which liquid crystal display device a gate ON voltage is supplied to the scanning signal line in a case where the scanning signal line is selected, a gate OFF voltage is supplied to the scanning signal line in a case where the scanning signal line is not selected, and a common voltage is supplied to the common electrode, the liquid crystal display device having a first mode and a second mode in which the liquid crystal display device is driven at a lower frequency than in the first mode, and in the second mode, at least one of an absolute value of the gate ON voltage and an absolute value of the gate OFF voltage being smaller than that in the first mode, and the common voltage being different from that in the first mode.

### Advantageous Effects of Invention

An aspect of the present invention makes it possible to improve a defect in a display which defect may occur at the time when a drive frequency of the liquid crystal display device is switched to another drive frequency.

Further, in the aspect of the present invention, at least one of the absolute value of the gate ON voltage and the absolute value of the gate OFF voltage is decreased in accordance with a variation in drive frequency (refresh rate). This makes it possible to reduce a power consumption of a scanning signal line drive circuit.

### BRIEF DESCRIPTION OF DRAWINGS

FIG. 1 is a view schematically illustrating a configuration example of a liquid crystal display device in accordance with an embodiment of the present invention.

FIG. 2 is a circuit diagram illustrating a configuration example of a subpixel.

FIG. 3 is a block diagram illustrating a configuration example of a display control circuit in accordance with an embodiment of the present invention.

FIG. 4 is a timing chart for explanation of a gate ON voltage and a gate OFF voltage, and a feed-through voltage.

FIG. 5 is a timing chart illustrating a driving method including a first mode and a second mode in accordance with Embodiment 1.

FIG. 6 is a timing chart illustrating a driving method including a first mode and a second mode in accordance with Embodiment 2.

FIG. 7 is a timing chart illustrating a driving method including a first mode and a second mode in accordance with Embodiment 3.

### DESCRIPTION OF EMBODIMENTS

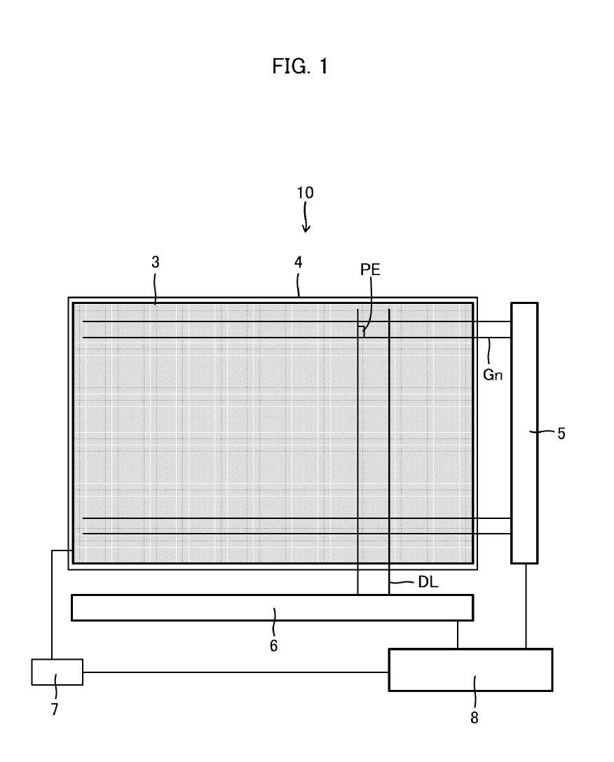

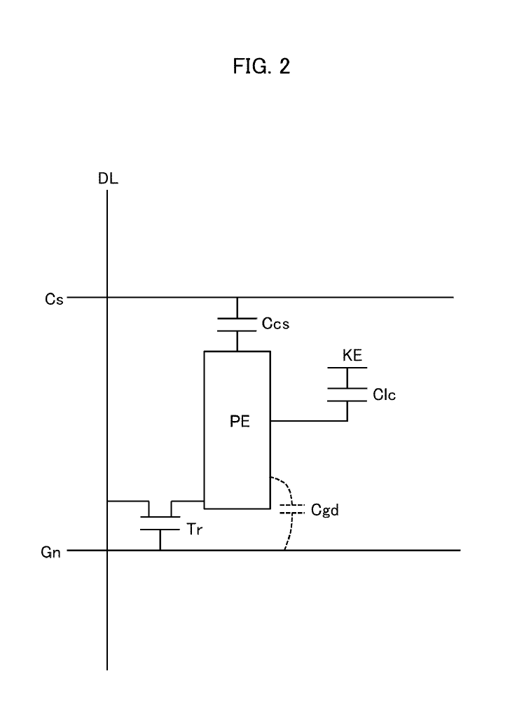

FIG. 1 is a view schematically illustrating a configuration example of a liquid crystal display device in accordance with an embodiment of the present invention. FIG. 2 is a circuit diagram illustrating a configuration example of a subpixel. As illustrated in FIGS. 1 and 2, a liquid crystal display device 10 includes a liquid crystal panel 3, a backlight unit 4, a gate driver (scanning signal line driving circuit) 5, a source driver 6, a Vcom supplying circuit 7, and a display control circuit 8. The gate driver 5 may be an IC which is configured separately from the liquid crystal panel 3 or alternatively may be configured like a gate driver monolithic circuit (GDM) which is monolithically formed in the liquid crystal panel 3.

The liquid crystal panel 3 includes pixel electrodes PE, a common electrode KE, transistors Tr, scanning signal lines Gn, data signal lines DL, and storage capacitor wirings Cs. A pixel electrode PE is connected with a data signal line DL and a scanning signal line Gn via a transistor Tr. Meanwhile, a liquid crystal capacitance Clc is formed between the pixel electrode PE and the common electrode KE, and a storage capacitor Ccs is formed between the pixel electrode PE and a storage capacitor wiring Cs. The subpixel is constituted by a color filter (not illustrated) and the liquid crystal capacitance Clc which serves as a shutter.

The transistor Tr has a channel which contains an oxide semiconductor such as an In—Ga—Zn—O based semiconductor. The In—Ga—Zn—O based semiconductor is a ternary oxide containing indium (In), gallium (Ga), and zinc (Zn). The ratio (i.e., compositional ratio) of In, Ga, and Zn is not limited to a particular one. The ratio (In:Ga:Zn) may be, for example, 2:2:1, 1:1:1, or 1:1:2. The In—Ga—Zn—O based semiconductor may be amorphous or crystalline.

The backlight unit 4 includes a light source such as an LED and emits light onto the liquid crystal panel 3. The gate driver 5 drives the scanning signal lines Gn. The source driver 6 drives the data signal lines DL. Meanwhile, the Vcom supplying circuit 7 supplies a common voltage (Vcom) to the common electrode KE and the storage capacitor wirings Cs.

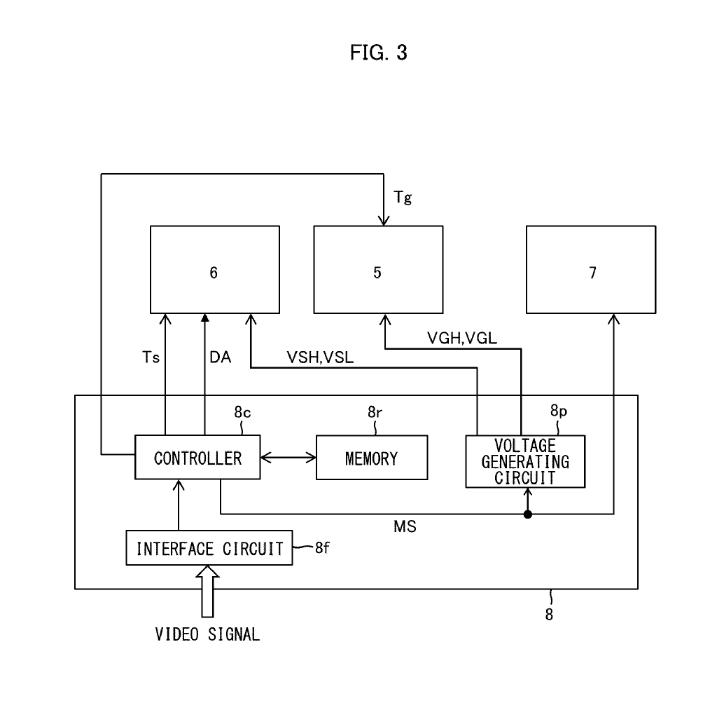

FIG. 3 is a block diagram illustrating a configuration example of the display control circuit 8 in accordance with an embodiment of the present invention. As illustrated in FIG. 3, the display control circuit 8 includes an interface circuit 8f, a controller 8c, a memory 8r, and a voltage generating circuit 8p, and controls the gate driver 5, the source driver 6 and the Vcom supplying circuit 7. Note that the voltage generating circuit 8p and the Vcom supplying circuit 7 may be formed on a single circuit board. The memory 8r and the interface circuit 8f may be built in the controller 8c.

More specifically, the controller 8c having received a video signal via the interface circuit 8f sends, in cooperation with the memory 8r, (i) video data DA and a timing signal Ts to the source driver 6, (ii) a timing signal Tg to the gate driver 5, and (iii) a mode signal MS to the voltage generating circuit 8p and the Vcom supplying circuit 7. The mode signal MS is a signal indicative of a first mode (e.g., driving at a normal frequency of 60 Hz) or a second mode (e.g., driving at a low frequency of less than 60 Hz). For example, the controller 8c sends the mode signal MS indicative of the first mode in a case where the video signal is a moving image signal whereas in a case where the video signal is a still image signal, the controller 8c sends the mode signal MS indicative of the second mode.

The voltage generating circuit 8p outputs source reference voltages VSH and VSL to the source driver 6. The voltage generating circuit 8p also outputs, to the gate driver 5, a gate ON voltage and a gate OFF voltage in accordance with the mode signal MS.

The source driver 6 supplies, to the data signal line DL, a source voltage (writing voltage) based on the source reference voltages VSH and VSL. The source voltage is supplied in accordance with the timing signal Ts and the video data DA. The gate driver 5 supplies, to the scanning signal line Gn, a gate signal (gate pulse) based on the gate ON voltage VGH and the gate OFF voltage VSL. The gate signal is supplied in accordance with the timing signal Tg. The Vcom supplying circuit 7 supplies a common voltage (Vcom) based on the mode signal MS to the common electrode KE and the storage capacitor wiring Cs.

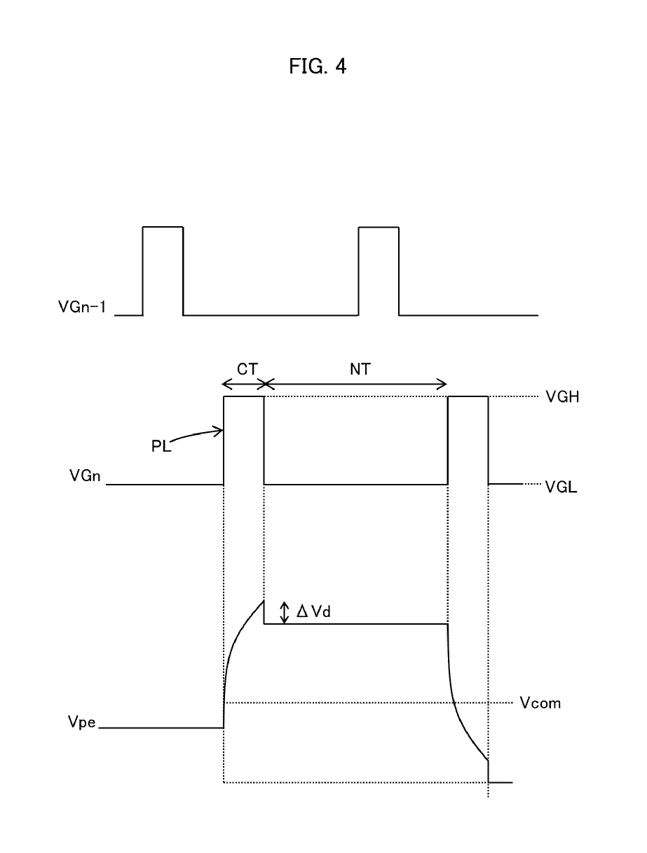

FIG. 4 is a timing chart for explanation of the gate ON voltage and the gate OFF voltage, and a feed-through voltage. During a non-selection period NT, the gate driver 5 supplies VGL to the scanning signal line Gn. On the other hand, during a selection period CT, the gate driver 5 supplies VGH to the scanning signal line Gn and turns on the transistor Tr. When a voltage VGn of the scanning signal line Gn rises from VGL to VGH, the source driver 6 supplies a source voltage to the data signal line DL. In a case where the polarity of the source voltage is positive, a voltage Vpe of the pixel electrode PE increases. Thereafter, at a time point when the voltage VGn of the scanning signal line Gn decreases from VGH back to VGL, a voltage ΔVd of the voltage Vpe of the pixel electrode PE becomes a feed-through voltage due to a parasitic capacitance Cgd (capacitance between the scanning signal line and the pixel electrode) illustrated in FIG. 2.

### Embodiment 1

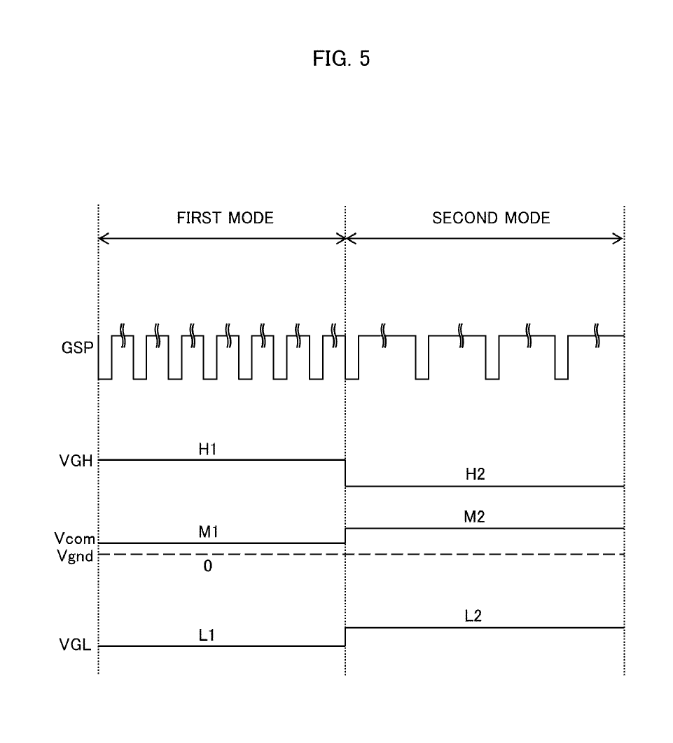

FIG. 5 is a timing chart illustrating a driving method including a first mode and a second mode in accordance with Embodiment 1. Hereinafter, the ground voltage Vgn is used as a reference (0V) when plus and minus of a voltage is indicated.

In a case where the controller 8c determines that, for example, a video signal is a moving image signal, the controller 8c sends timing signals Ts and Tg for the first mode and a mode signal MS indicative of the first mode. As illustrated in FIG. 5, in the first mode (driving at a normal frequency), the frequency of a gate start pulse GSP, which is one of timing signals Tg, is 60 [Hz]. The voltage generating circuit 8p having received the mode signal MS indicative of the first mode sets VGH to a positive voltage H1, which VGH is a voltage to be outputted to the gate driver 5, and also sets VGL to a negative voltage L1, which VGL is to be outputted to the gate driver 5. Meanwhile, the Vcom supplying circuit 7 having received the mode signal MS indicative of the first mode sets Vcom to a positive voltage M1.

In a case where the controller 8c determines that, for example, the video signal is a still image signal, the controller 8c sends timing signals Ts and Tg for the second mode and a mode signal MS indicative of the second mode. As illustrated in FIG. 5, in the second mode (driving at a low frequency), the frequency of the gate start pulse GSP, which is one of timing signals Tg, is 30 [Hz]. The voltage generating circuit 8p having received the mode signal MS indicative of the second mode sets VGH to a positive voltage H2, which VGH is a voltage to be outputted to the gate driver 5, and also sets VGL to a negative voltage L2, which VGL is to be outputted to the gate driver 5. Meanwhile, the Vcom supplying circuit 7 having received the mode signal MS indicative of the second mode sets Vcom to a positive voltage M2.

In FIG. 5, the absolute value of the positive voltage H2<the absolute value of the positive voltage H1, the absolute value of the negative voltage L2<the absolute value of the negative voltage L1, and the absolute value of the positive voltage M2>the absolute value of the positive voltage M1.

In the second mode, one horizontal scanning period (1H) can be long since a drive frequency (refresh rate) is small. Accordingly, the absolute value of the voltage H2 is set smaller than the absolute value of the voltage H1. This makes it possible to reduce a power consumption without causing any problem in charging rate of the pixel electrode. Meanwhile, the transistor Tr includes a channel which contains an oxide semiconductor, and has a high switching characteristic. Therefore, the absolute value of the voltage L2 is set smaller than the absolute value of the voltage L1. Then, the power consumption can be reduced while leak current is suppressed.

The value of a source voltage supplied to the data signal line DL by the source driver 6 is set in consideration of a feed-through voltage ΔVd shown in FIG. 4. As a gate pulse PL becomes lower (a different between VGH and VGL becomes smaller), the feed-through voltage ΔVd becomes smaller. Accordingly, the feed-through voltage ΔVd is smaller in the second mode than in the first mode. Therefore, in a case where the source voltage and the common voltage (Vcom) are each configured to be the same between the first mode and the second mode, there arises problems such as flickering and image sticking that is caused by application of a DC voltage (deterioration in reliability). In view of the above, a decrease in the feed-through voltage ΔVd in the second mode is taken into consideration and the absolute value of the common voltage (positive voltage M2) in the second mode is set larger than the absolute value of the common voltage (positive voltage M1) in the first mode (a Vcom level is increased), so that such a change in the feed-through voltage ΔVd is compensated by correction of Vcom. The above makes it possible to dissolve the above problems and to set one source voltage corresponding to a piece of data for the same color and gradation level for both the first mode and the second mode (correction of the source voltage in the second mode becomes unnecessary).

Though in the above description, the drive frequency (refresh rate) in the first mode is set to not less than 60 Hz and the drive frequency in the second mode is set to less than 60 Hz, drive frequencies in an embodiment of the present invention is not limited to those frequencies. Alternatively, the drive frequency in the first mode can set to less than 60 Hz (the drive frequency in the second mode<the drive frequency in the first mode) or the drive frequency in the second mode can be set to not less than 60 Hz (the drive frequency in the first mode>the drive frequency in the second mode).

### Embodiment 2

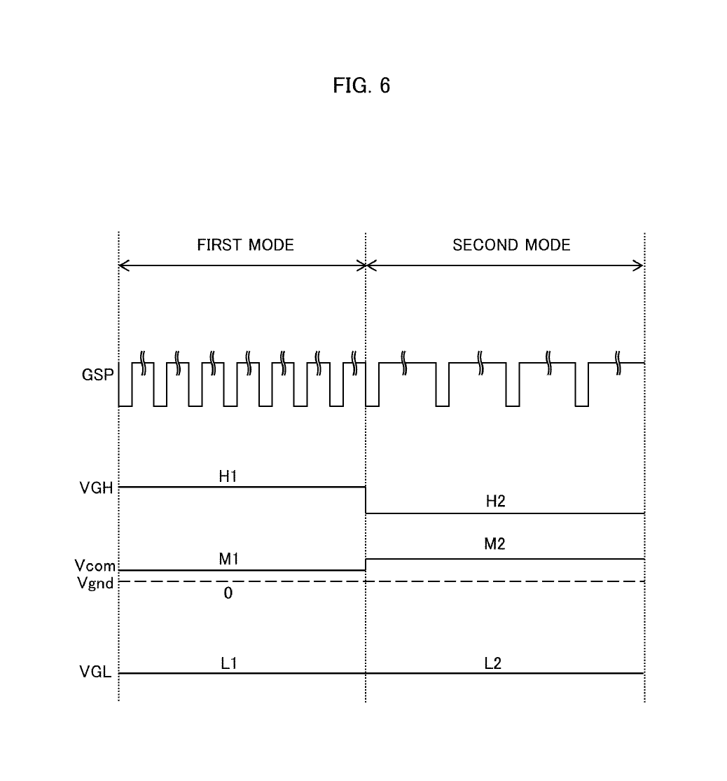

FIG. 6 is a timing chart illustrating a driving method including a first mode and a second mode in accordance with Embodiment 2. In FIG. 6, the absolute value of a positive voltage H2<the absolute value of a positive voltage H1, the absolute value of a negative voltage L2=the absolute value of a negative voltage L1, and the absolute value of a positive voltage M2>the absolute value of a positive voltage M1. In this way, in the second mode, it is possible to change only VGH and Vcom from those in the first mode and keep VGL unchanged from that in the first mode.

### Embodiment 3

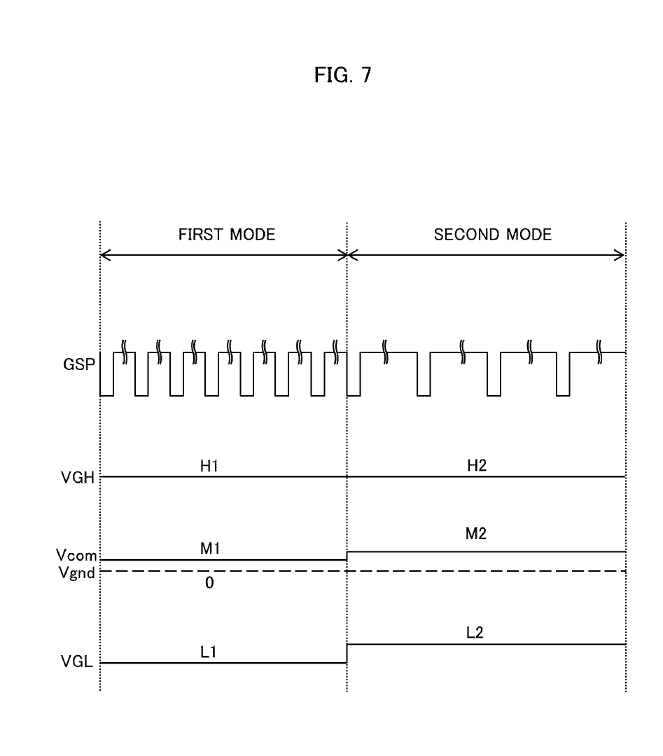

FIG. 7 is a timing chart illustrating a driving method including a first mode and a second mode in accordance with Embodiment 3. In FIG. 7, the absolute value of a positive voltage H2=the absolute value of a positive voltage H1, the absolute value of a negative voltage L2<the absolute value of a negative voltage L1, and the absolute value of a positive voltage M2>the absolute value of a positive voltage M1. In this way, in the second mode, it is possible to change only VGL and Vcom from those in the first mode and keep VGH unchanged from that in the first mode.

### Embodiment 4

The above embodiments dealt with configurations in each of which when a transistor is turned off, a feed-through voltage ΔVd (potential difference, see FIG. 4) in a second mode is smaller than that in a first mode. This is because in the above embodiments, a gate pulse in the second mode is lower than that in the first mode due to a change of at least one of VGH and VGL in the second mode from that in the first mode. In a case where in the second mode, (i) the gate pulse is higher than that in the first mode due to a change of at least one of VGH and VGL from that in the first mode and (ii) when the transistor is turned off, the feed-through voltage ΔVd is larger than that in the first mode, the level of Vcom can be reduced so that Vcom will be closer to Vgnd (the absolute value of the positive voltage M2<the absolute value of the positive voltage M1).

### [Aspect 1]

A liquid crystal display device including: a pixel electrode connected with a data signal line and a scanning signal line, via a transistor; and a common electrode which forms a liquid crystal capacitance, together with the pixel electrode, in which liquid crystal display device a gate ON voltage is supplied to the scanning signal line in a case where the scanning signal line is selected, a gate OFF voltage is supplied to the scanning signal line in a case where the scanning signal line is not selected, and a common voltage is supplied to the common electrode, the liquid crystal display device having a first mode and a second mode in which the liquid crystal display device is driven at a lower frequency than in the first mode, and in the second mode, at least one of an absolute value of the gate ON voltage and an absolute value of the gate OFF voltage being smaller than that in the first mode, and the common voltage being different from that in the first mode.

### [Aspect 2]

The liquid crystal display device as described in, for example, Aspect 1, wherein in the second mode, the absolute value of the gate ON voltage is smaller than that in the first mode.

### [Aspect 3]

The liquid crystal display device as described in, for example, Aspect 1 or 2, wherein in the second mode, the absolute value of the gate OFF voltage is smaller than that in the first mode.

### [Aspect 4]

The liquid crystal display device as described in, for example, any one of Aspects 1 to 3, wherein: the transistor has an n-type channel; a value of the common voltage is positive with reference to a ground voltage, in each of both the first mode and the second mode; and in the second mode, the absolute value of the common voltage is larger than that in the first mode.

### [Aspect 5]

The liquid crystal display device as described in, for example, any one of Aspects 1 to 4, wherein a channel of the transistor contains an oxide semiconductor.

### [Aspect 6]

The liquid crystal display device as described in, for example, any one of Aspects 1 to 5, wherein: a source voltage is supplied to the data signal line; and the source voltage corresponding to a piece of data for same color and gradation level is common to the first mode and the second mode.

### [Aspect 7]

The liquid crystal display device as described in, for example, any one of Aspects 1 to 6, the liquid crystal display device being driven at a frequency of not less than 60 Hz in the first mode and is driven at a frequency of less than 60 Hz in the second mode.

### [Aspect 8]

A method for driving a liquid crystal panel including: a pixel electrode connected with a data signal line and scanning signal line, via a transistor; and a common electrode which forms a liquid crystal capacitance, together with the pixel electrode, in which liquid crystal panel a gate ON voltage is supplied to the scanning signal line in a case where the scanning signal line is selected, a gate OFF voltage is supplied to the scanning signal line in a case where the scanning signal line is not selected, and a common voltage is supplied to the common electrode, the method comprising a first mode and a second mode in which the liquid crystal panel is driven at a frequency which is different from that in the first mode, in the second mode, at least one of an absolute value of the gate ON voltage and an absolute value of the gate OFF voltage being different from that in the first mode, and the common voltage being different from that in the first mode.

### [Aspect 9]

The liquid crystal display device as described in, for example, any one of Aspects 1 to 6, which is driven at a frequency of less than 60 Hz in the first mode and which is driven in the second mode at a frequency lower than that in the first mode.

### [Aspect 10]

The liquid crystal display device as described in, for example, any one of Aspects 1 to 6, which is driven at a frequency above 60 Hz in the first mode and which is driven in the second mode at a frequency that is not less than 60 Hz and lower than that in the first mode.

### REFERENCE SIGNS LIST

3 liquid crystal panel
4 backlight unit
5 gate driver
6 source driver
7 Vcom supplying circuit
8 display control circuit
10 liquid crystal display device
Gn scanning signal line
DL data signal line
Tr transistor
KE common electrode
PE pixel electrode
VGH gate ON voltage
VGL gate OFF voltage
Vcom common voltage

1. A liquid crystal display device including: a pixel electrode connected with a data signal line and a scanning signal line, via a transistor; and a common electrode which forms a liquid crystal capacitance, together with the pixel electrode, in which liquid crystal display device a gate ON voltage is supplied to the scanning signal line in a case where the scanning signal line is selected, a gate OFF voltage is supplied to the scanning signal line in a case where the scanning signal line is not selected, and a common voltage is supplied to the common electrode,
the liquid crystal display device having a first mode and a second mode in which the liquid crystal display device is driven at a lower frequency than in the first mode, and
in the second mode, at least one of an absolute value of the gate ON voltage and an absolute value of the gate OFF voltage being smaller than that in the first mode, and the common voltage being different from that in the first mode.

2. The liquid crystal display device as set forth in claim 1, wherein in the second mode, the absolute value of the gate ON voltage is smaller than that in the first mode.

3. The liquid crystal display device as set forth in claim 1, wherein in the second mode, the absolute value of the gate OFF voltage is smaller than that in the first mode.

4. The liquid crystal display device as set forth in claim 1, wherein:
the transistor has an n-type channel;
a value of the common voltage is positive with reference to a ground voltage, in each of both the first mode and the second mode; and
in the second mode, the absolute value of the common voltage is larger than that in the first mode.

5. The liquid crystal display device as set forth in claim 1, wherein a channel of the transistor contains an oxide semiconductor.

6. The liquid crystal display device as set forth in claim 1, wherein:
a source voltage is supplied to the data signal line; and
the source voltage corresponding to a piece of data for same color and gradation level is common to the first mode and the second mode.

7. The liquid crystal display device as set forth in claim 1, the liquid crystal display device being driven at a frequency of not less than 60 Hz in the first mode and is driven at a frequency of less than 60 Hz in the second mode.

8. A method for driving a liquid crystal panel including: a pixel electrode connected with a data signal line and scanning signal line, via a transistor; and a common electrode which forms a liquid crystal capacitance, together with the pixel electrode, in which liquid crystal panel a gate ON voltage is supplied to the scanning signal line in a case where the scanning signal line is selected, a gate OFF voltage is supplied to the scanning signal line in a case where the scanning signal line is not selected, and a common voltage is supplied to the common electrode,
the method comprising a first mode and a second mode in which the liquid crystal panel is driven at a frequency which is different from that in the first mode,
in the second mode, at least one of an absolute value of the gate ON voltage and an absolute value of the gate OFF voltage being different from that in the first mode, and the common voltage being different from that in the first mode.
